(19) United States
(12) Patent Application Publication
(10) Pub. No.: US 2021/0145208 A1
(43) Pub. Date: May 20, 2021

(54) HEATING DEVICE AND COFFEE MACHINE

(71) Applicant: TSANN KUEN (ZHANG ZHOU) ENTERPRISE CO., LTD., Zhang Zhou City (CN)

(72) Inventor: YANXIANG ZHANG, Zhangzhou City (CN)

(21) Appl. No.: 17/033,870

(22) Filed: Sep. 27, 2020

(30) Foreign Application Priority Data
Nov. 15, 2019 (CN) 201911121584.7

(51) Int. Cl. A47J 31/54; A47J 31/56; F24H 9/00

(52) U.S. Cl. CPC A47J 31/542; A47J 2202/00; F24H 9/0015; A47J 31/56

(57) ABSTRACT

The present invention provides a heating device, including a heating body. The heating body is provided with a fluid inlet, a fluid outlet and a flow channel, wherein one of the fluid inlet and the fluid outlet is arranged in an edge area of the heating body, and the other one of the fluid inlet and the fluid outlet is arranged in a central area of the heating body. The flow channel is arranged spirally along a circumferential direction of the heating body and communicates the fluid inlet with the fluid outlet. The present invention further provides a coffee machine including the heating device, and the fluid being heated by the heating device is water. The heating device and the coffee machine can improve the stability of the temperature of the outlet water and improve the taste and quality of the brewed coffee.

### CROSS-REFERENCE TO RELATED APPLICATION

The present invention is based on and claims the priority of Chinese patent application No. 201911121584.7, filed on Nov. 15, 2019. The entire disclosure of the above-identified application is incorporated herein by reference.

### TECHNICAL FIELD

The present invention relates to the technical field of household appliances, and in particular, to a heating device and a coffee machine with the heating device.

### BACKGROUND OF THE INVENTION

At present, most coffee machines on the market control the water temperature by controlling the heating temperature of the heating device, and then control the temperature of the brewed coffee, so as to improve the taste and quality of coffee. However, the structure design of the existing heating device cannot heat the water evenly, which results in the temperature of the outlet water being high and low, and the temperature of the coffee is unstable, which affects the taste and quality of the coffee.

### SUMMARY OF THE INVENTION

In view of the above technical problems, the present invention provides a heating device and a coffee machine, which can improve the stability of the temperature of the outlet water.

In order to solve the above technical problems, the present invention provides a heating device including a heating body. The heating body is provided with a fluid inlet, a fluid outlet and a flow channel, wherein one of the fluid inlet and the fluid outlet is arranged in an edge area of the heating body, and the other one of the fluid inlet and the fluid outlet is arranged in a central area of the heating body. The flow channel is arranged spirally along a circumferential direction of the heating body and communicates the fluid inlet with the fluid outlet.

Further, an electric heating tube is provided in the heating body, and the electric heating tube is arranged along a circumference of the heating body.

Further, the electric heating tube is integrally formed with the heating body.

Further, the heating device further includes a pressing plate and a sealing element. The sealing element is arranged at an upper opening of the flow channel to seal and separate adjacent flow channels. The pressing plate is connected with the heating body to press and fix the sealing element.

Further, the sealing element is provided with a convex structure. The convex structure is compressed and deformed by the pressing plate and the heating body to seal the flow channel.

Further, a side wall of the fluid outlet is provided with a plurality of grooves. The plurality of grooves extends along a longitudinal direction of the heating body and have lateral openings facing a center of the fluid outlet.

Further, the plurality of grooves is arranged continuously along a circumference of the fluid outlet.

Further, the fluid inlet is arranged in the edge area of the heating body, and the fluid outlet is arranged in the central area of the heating body.

Further, the heating device further includes a temperature detection component, and the temperature detection component is arranged on the heating body and corresponds to the position of the fluid outlet.

The present invention further provides a coffee machine which includes the heating device as described above, and the fluid being heated by the heating device is water.

The present invention further provides a coffee machine including a heating body, a pressing plate and a sealing element. The heating body is provided with a fluid inlet, a fluid outlet and a flow channel, wherein one of the fluid inlet and the fluid outlet is arranged in an edge area of the heating body, and the other one of the fluid inlet and the fluid outlet is arranged in a central area of the heating body. The flow channel is a spiral groove formed in the heating body and communicates the fluid inlet with the fluid outlet. The sealing element is disposed between the heating body and the pressing plate. The pressing plate is fixed to the heating body so that the sealing element is sandwiched between the heating body and the pressing plate to seal an upper opening of the flow channel.

Further, the fluid inlet is arranged in the edge area of the heating body, and the fluid outlet is arranged in the central area of the heating body.

Further, a circumference of the fluid outlet is provided with a plurality of grooves. The plurality of grooves extends along a thickness direction of the heating body and have lateral openings facing a center of the fluid outlet.

Further, the fluid inlet is connected with an inlet pipe, and the fluid outlet is connected with an outlet pipe, so that water enters the flow channel from the fluid inlet through the inlet pipe, flows to the fluid outlet along the flow channel, and discharges out of the heating body through the outlet pipe.

Further, the sealing element is provided with a convex structure. The convex structure is compressed and deformed by the pressing plate and the heating body to seal the flow channel.

Further, an electric heating tube is provided in a bottom wall of the heating body for heating the water as the water flows through the flow channel.

Further, the coffee machine further includes a temperature detection component arranged on the heating body and configured for detecting a temperature of the water at the fluid outlet.

As described above, the heating device of the present invention includes a heating body. The heating body is provided with a fluid inlet, a fluid outlet and a flow channel, wherein one of the fluid inlet and the fluid outlet is arranged in an edge area of the heating body, and the other one of the fluid inlet and the fluid outlet is arranged in a central area of the heating body. The flow channel is arranged spirally along a circumferential direction of the heating body and communicates the fluid inlet with the fluid outlet. The coffee machine of the present invention includes the heating device, and the fluid being heated by the heating device is water. In the heating device of the present invention, since the fluid inlet and the fluid outlet are respectively arranged in the edge area and the central area of the heating body, the water temperature at the fluid inlet can be prevented from affecting the water temperature at the fluid outlet. At the same time, the fluid inlet and the fluid outlet are communicated through a spiral flow channel, which can increase the length of the flow channel, prolong the residence time of the fluid in the heating body and increase the heating area, so that the fluid is fast and evenly heated to the required temperature. When the heating device is used to heat water, it can improve the stability of the temperature of the outlet water and improve the taste and quality of the brewed coffee.

### BRIEF DESCRIPTION OF THE DRAWINGS

FIG. 1 is an exploded schematic view of a heating device according to an embodiment;

FIG. 2 is an assembled schematic view of the heating device in FIG. 1;

FIG. 3 is another assembled schematic view of the heating device in FIG. 1;

FIG. 4 is an exploded schematic view of the heating body in FIG. 1;

FIG. 5 is a top plan view of the heating body in FIG. 1;

FIG. 6 is a cross-sectional view of the heating body along line I-I in FIG. 5;

FIG. 7 is a schematic view of the heating body in FIG. 1; and

FIG. 8 is an enlarged view of the fluid outlet area of the heating body in FIG. 7.

### DETAILED DESCRIPTION OF PREFERRED EMBODIMENTS

In the following, the implementation mode of the present invention is described by specific embodiments. Persons familiar with the technology can easily understand other advantages and effects of the present invention from the contents disclosed in the specification.

In the following description, several embodiments of the present invention are described with reference to the accompanying drawings. It should be understood that other embodiments may be used and that changes in mechanical composition, structure, electricity and operation may be made without departing from the spirit and scope of the present invention. The following detailed description should not be considered restrictive, and the scope of the embodiments of the present invention is limited only by the claims of the patent. The terms used herein are intended to describe specific embodiments only and are not intended to limit the present invention.

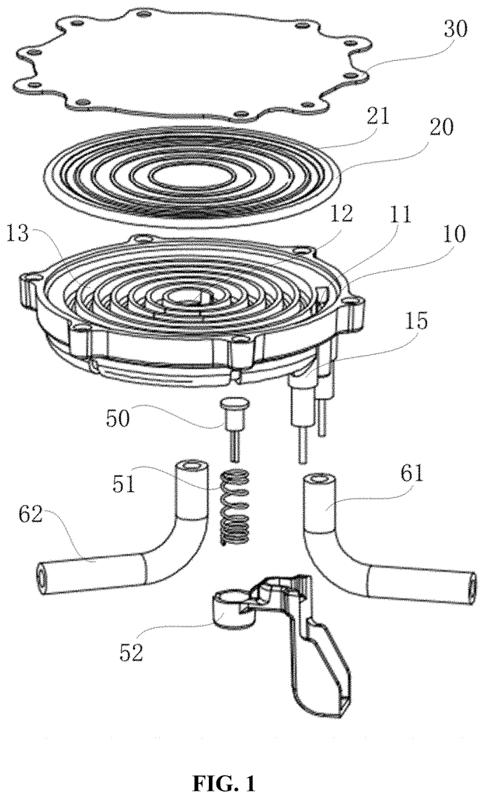

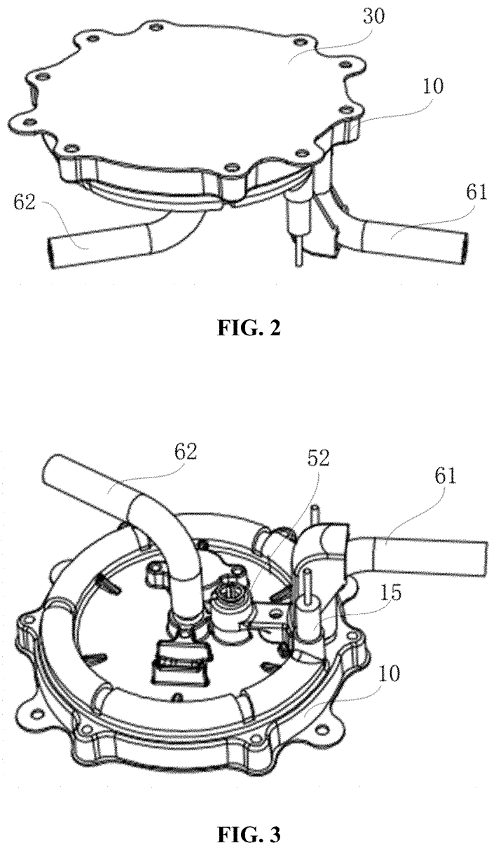

The heating device of this embodiment can be used to heat water, oil and other fluids. Please refer to FIG. 1, FIG. 2 and FIG. 3, the heating device of this embodiment includes a pressing plate 30, a sealing element 20 and a heating body 10. The pressing plate 30, the sealing element 20 and the heating body 10 are stacked in sequence as listed and connected through fasteners to form a whole.

The heating body 10 is provided with a fluid inlet 11, a fluid outlet 12 and a flow channel 13. In this embodiment, the fluid inlet 11 is arranged in the edge area of the heating body 10, the fluid outlet 12 is arranged in the central area of the heating body 10, and the flow channel 13 is arranged spirally along the circumferential direction of the heating body 10 and communicates the fluid inlet 11 with the fluid outlet 12.

Specifically, the heating body 10 is in the shape of a disc. The fluid inlet 11 is higher than the bottom wall of the heating body 10 and is perpendicular to the bottom wall of the heating body 10. The fluid outlet 12 is a through hole penetrating through the center of the bottom wall of the heating body 10. The flow channel 13 is a spiral groove formed in the heating body 10 and is located in the same plane. The fluid inlet 11 is connected with an inlet pipe 61, and the fluid outlet 12 is connected with an outlet pipe 62, so that the water enters the flow channel 13 of the heating body 10 from the fluid inlet 11 through the inlet pipe 61, flows to the fluid outlet 12 along the extension direction of the flow channel 13, and then discharges out of the heating body 10 through the outlet pipe 62.

Because the fluid inlet 11 and fluid outlet 12 are respectively arranged in the edge area and the central area of the heating body 10, the distance between them is relatively long, which can avoid the influence of the fluid temperature of the fluid inlet 11 on the fluid temperature of the fluid outlet 12. Meanwhile, the fluid inlet 11 is communicated with the fluid outlet 12 through a spiral flow channel 13, and the length of the flow channel 13 is relatively long, which can prolong the residence time of the fluid in the heating body 10 and increase the heating area, to thereby make the fluid quickly and evenly heated to the specified temperature and improve the stability of the temperature of the fluid at the fluid outlet 12. Due to the adoption of the spiral flow channel 13, the size of the heating body 10 can be reduced without affecting the heating efficiency, thus achieving the effect of small volume and fast heating speed.

It can be understood that in another embodiment, the fluid outlet 12 may be arranged in the edge area of the heating body 10, and the fluid inlet 11 is arranged in the central area of the heating body 10, such an arrangement can also achieve the above effects.

The sealing element 20 is arranged at the upper opening of the flow channel 13, such that the flow channel 13 is sealed and separated. The pressing plate 30 is connected with the heating body 10 through fasteners, so as to press and fix the sealing element 20. The sealing element 20 is, for example, a silicone rubber. In this embodiment, the sealing element 20 is provided with a convex structure 21, which is compressed and deformed by the pressing plate 30 and the heating body 10 to seal the flow channel 13. In this way, after the sealing element 20 is fixed, the convex structure 21 is pressed between the upper surface of the side wall of the flow channel 13 and the pressing plate 30 to cause a certain deformation, so as to fully seal and isolate the flow channel 13. Even if the pressing plate 30 and the heating body 10 may deform due to relative small displacement during use, the sealing and isolation of the flow channel 13 can be maintained through the deformation of the convex structure 21 on the sealing element 20, so as to avoid the occurrence of cross flow. In practice, the convex structure 21 can be arranged spirally along the circumferential direction of the sealing element 20 and is located corresponding to the side wall of the flow channel 13, that is, the convex structure 21 is also in a spiral shape. Alternatively, the convex structure 21 may also be formed into a plurality of rings with different diameters and are arranged concentrically around the fluid outlet 12, so long as it can fully seal the flow channel 13 during compression.

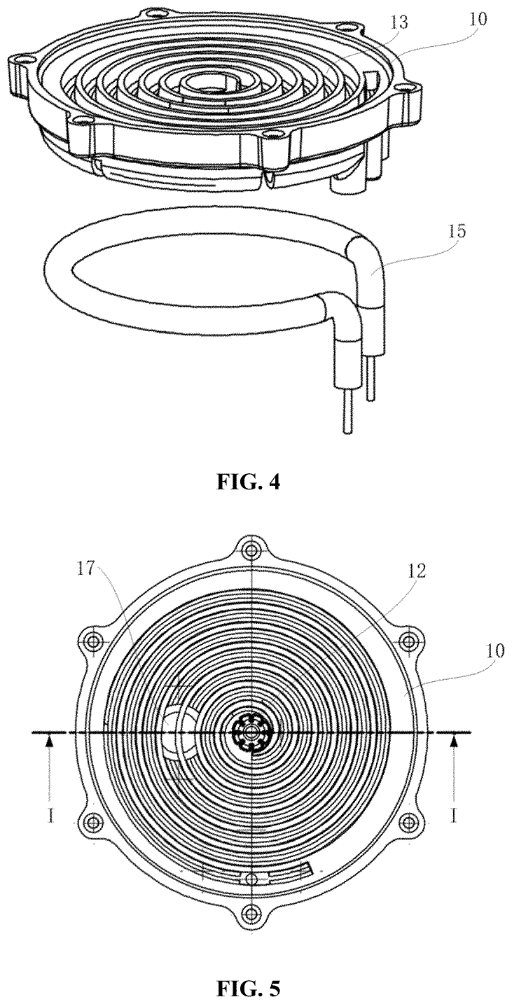

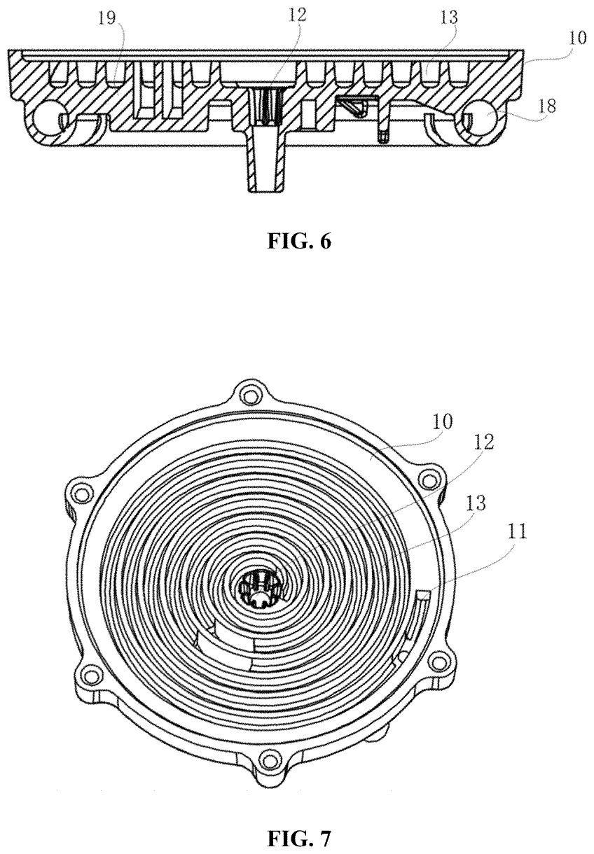

Referring to FIG. 4, FIG. 5 and FIG. 6, an electric heating tube 15 is provided in the heating body 10. The electric heating tube 15 is arranged along the circumference of the heating body 10. The electric heating pipe 15 is controlled to be electrified to provide the heat source needed by the heating body 10. Since the electric heating tube 15 is arranged along the circumference of the heating body 10 and matches with the spiral flow channel 13, the heating body 10 can be heated uniformly as a whole, so that the fluid in the flow channel 13 can be quickly and evenly heated to the specified temperature during flowing. In this embodiment, the electric heating tube 15 and the heating body 10 are integrally formed, the heating body 10 defines a receiving cavity 18 on the back side thereof away from the flow channel 13, and the electric heating tube 15 is fixed in the receiving cavity 18, so as to form a whole with the heating body 10. Through integrated molding and manufacturing, the electric heating tube 15 can be more fully contacted with the heating body 10, and the heat utilization rate and heat transfer stability can be improved.

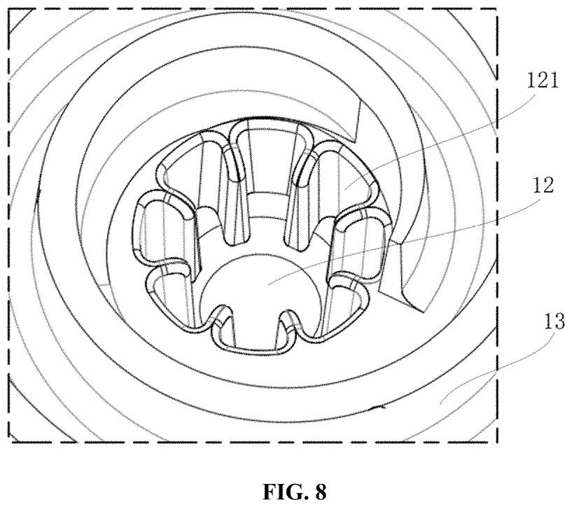

As shown in FIG. 7 and FIG. 8, the fluid outlet 12 vertically penetrates through the center of the bottom wall 19 of the heating body 10. In this embodiment, the fluid outlet 12 includes a plurality of grooves 121 which extend along a longitudinal direction of the heating body 10 and have lateral openings facing the center of the fluid outlet 12. In other words, the side wall of the fluid outlet 12 is provided with a plurality of grooves 121 for the heated fluid to flow through, and these grooves 121 extend along the thickness direction of the heating body 10. The arrangement of the grooves 121 increases the area of the side wall of the fluid outlet 12 and forms a plurality of flow passages, thus increasing the contact area between the fluid and the heating body 10, making the fluid more fully contact with the heating body 10 and heating the fluid more evenly, to further improve the stability of the temperature of the fluid. In this embodiment, the plurality of grooves 121 is arranged continuously along the circumference of the fluid outlet 12, so that the cross section of the fluid outlet 12 is shaped like a petal, and the contact area is optimized without affecting the flow rate.

As shown in FIG. 1 and FIG. 3, the heating device of this embodiment further includes a temperature detection component 50, which is arranged on the heating body 10 and corresponds to the position of the fluid outlet 12, so that the fluid temperature at the fluid outlet 12 can be detected. For example, the temperature detection component 50 is an NTC (negative temperature coefficient) temperature sensor, which is compressed by a spring 51 and fixed on the heating body 10 by a fixing frame 52. In this embodiment, the temperature detection component 50 is arranged on the back side of the installation position 17 shown in FIG. 5, so as to be close to the fluid outlet 12 and not directly contact with the fluid, which is convenient for maintenance and can detect the fluid temperature at the fluid outlet 12 accurately.

As mentioned above, in the heating device of the present invention, since the fluid inlet and the fluid outlet are respectively arranged in the edge area and the central area of the heating body, the water temperature at the fluid inlet can be prevented from affecting the water temperature at the fluid outlet. At the same time, the fluid inlet and the fluid outlet are communicated through a spiral flow channel, which can increase the length of the flow channel, prolong the residence time of the fluid in the heating body, and make the fluid be heated more uniformly, thereby improving the stability of the temperature of the fluid at the fluid outlet.

The present invention further provides a coffee machine, which includes the heating device as described above, and the fluid being heated by the heating device is water. When the coffee machine operates, the electric heating tube 15 of the heating device is controlled to preheat the heating body 10 to a preset temperature, and then the water is pumped through a water pump so that the water enters the flow channel 13 in the heating body 10 through the fluid inlet 11 of the heating body 10, and then flows along the spiral flow channel 13 to the fluid outlet 12. In this process, the heating body 10 heats the water to the temperature of making coffee. Since the flow channel 13 is relatively long and the fluid outlet 12 is provided with the grooves 121, the water is fully and evenly heated in the heating body 10 and quickly reaches the required temperature, and the temperature of the water flowing out from the fluid outlet 12 is stable, such that the coffee temperature is stable, the taste and quality of the brewed coffee is improved, and the user experience is enhanced.

The above-mentioned embodiment only illustrates the principle and the effects of the present invention, and is not used to limit the present invention. Any person familiar with the technology may modify or change the above-mentioned embodiment without departing from the spirit and scope of this invention. Therefore, all equivalent modifications or changes made by a person with ordinary knowledge in the technical field without departing from the spirit and technical ideas disclosed in the present invention shall still be covered by the claims of the present invention.

What is claimed is:

1. A heating device comprising a heating body, the heating body being provided with a fluid inlet, a fluid outlet and a flow channel, wherein one of the fluid inlet and the fluid outlet is arranged in an edge area of the heating body, and the other one of the fluid inlet and the fluid outlet is arranged in a central area of the heating body, the flow channel is arranged spirally along a circumferential direction of the heating body and communicates the fluid inlet with the fluid outlet.

2. The heating device according to claim 1, wherein an electric heating tube is provided in the heating body, and the electric heating tube is arranged along a circumference of the heating body.

3. The heating device according to claim 2, wherein the electric heating tube is integrally formed with the heating body.

4. The heating device according to claim 1, wherein the heating device further comprises a pressing plate and a sealing element, the sealing element is arranged at an upper opening of the flow channel to seal and separate adjacent flow channels, the pressing plate is connected with the heating body to press and fix the sealing element.

5. The heating device according to claim 4, wherein the sealing element is provided with a convex structure, the convex structure is compressed and deformed by the pressing plate and the heating body to seal the flow channel.

6. The heating device according to claim 1, wherein a side wall of the fluid outlet is provided with a plurality of grooves, the plurality of grooves extends along a longitudinal direction of the heating body and have lateral openings facing a center of the fluid outlet.

7. The heating device according to claim 6, wherein the plurality of grooves is arranged continuously along a circumference of the fluid outlet.

8. The heating device according to claim 1, wherein the fluid inlet is arranged in the edge area of the heating body, and the fluid outlet is arranged in the central area of the heating body.

9. The heating device according to claim 1, wherein the heating device further comprises a temperature detection component, and the temperature detection component is arranged on the heating body and corresponds to the position of the fluid outlet.

10. A coffee machine comprising the heating device according to claim 1, wherein the fluid being heated by the heating device is water.

11. A coffee machine comprising a heating body, a pressing plate and a sealing element, the heating body being provided with a fluid inlet, a fluid outlet and a flow channel, wherein one of the fluid inlet and the fluid outlet is arranged in an edge area of the heating body, and the other one of the fluid inlet and the fluid outlet is arranged in a central area of the heating body, the flow channel is a spiral groove formed in the heating body and communicates the fluid inlet with the fluid outlet, the sealing element is disposed between the heating body and the pressing plate, the pressing plate is fixed to the heating body so that the sealing element is sandwiched between the heating body and the pressing plate to seal an upper opening of the flow channel.

12. The coffee machine according to claim 11, wherein the fluid inlet is arranged in the edge area of the heating body, and the fluid outlet is arranged in the central area of the heating body.

13. The coffee machine according to claim 12, wherein a circumference of the fluid outlet is provided with a plurality of grooves, the plurality of grooves extends along a thickness direction of the heating body and have lateral openings facing a center of the fluid outlet.

14. The coffee machine according to claim 12, wherein the fluid inlet is connected with an inlet pipe, and the fluid outlet is connected with an outlet pipe, so that water enters the flow channel from the fluid inlet through the inlet pipe, flows to the fluid outlet along the flow channel, and discharges out of the heating body through the outlet pipe.

15. The coffee machine according to claim 11, wherein the sealing element is provided with a convex structure, the convex structure is compressed and deformed by the pressing plate and the heating body to seal the flow channel.

16. The coffee machine according to claim 11, wherein an electric heating tube is provided in a bottom wall of the heating body for heating the water as the water flows through the flow channel.

17. The coffee machine according to claim 11, further comprising a temperature detection component arranged on the heating body and configured for detecting a temperature of the water at the fluid outlet.
